(19) United States
(12) Patent Application Publication
(10) Pub. No.: US 2005/0102081 A1
(43) Pub. Date: May 12, 2005

(54) Lift truck active load stabilizer

(76) Inventor: Mark Alan Patterson, Beavercreek, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 10/668,571

(22) Filed: Sep. 23, 2003

(51) Int. Cl. G06G 7/00

(52) U.S. Cl. 701/50

(57) ABSTRACT

A lift truck having an acceleration sensor and a feedback control system for automatically adjusting the tilt angle of the load supporting surface relative to the lift truck during lift truck operation. The control system maintains the load supporting surface substantially perpendicular to the direction of the resultant of the gravitational force vector and the travel acceleration force vector. The sensor is mounted to the mast for sensing the direction of the resultant vector and is connected as the feedback element of the control system. A controller stores a reference input comprising a stored value of angular direction representing the angular direction of the resultant vector when the lift truck is at rest and the cargo support fork is horizontal. The deviation or error of the control system is the difference between the stored vector direction and the sensed vector direction of the resultant of the two accelerations. The controlled element of the feedback control system, to which the control system output is connected, is the mast tilt actuator of the lift truck. The mast tilt angle relative to the lift truck is controllably varied to bring the currently sensed resultant angular direction into alignment with the stored reference angular direction.

### (e) BACKGROUND OF THE INVENTION

1. Field of the Invention

This invention relates generally to cargo transporting lift trucks and more particularly relates to the stabilization of the load or cargo on such trucks by control of the orientation of the lift truck's fork through control of the tilt angle of the lift truck's lift mast in order to improve safety and reduce cargo damage as a result of cargo shifting on or falling from the fork.

2. Description of the Related Art

Lift trucks, sometimes referred to as fork lifts or fork lift trucks, have long found extensive use for transporting a cargo, such as a pallet stacked with goods or long rolled goods, from one location to another. For example, lift truck are used for loading or unloading larger transportation vehicles or moving inventory in a manufacturing plant. Typically, a lift truck has a cargo support, usually a generally horizontally extending fork, mounted to a lift mast. The cargo support can be any support mounted to or substituted for the fork to support a cargo. The cargo support is moved generally vertically along the mast or along with a telescoping mast so the cargo support surface can be raised to any height ranging from the surface on which the lift truck travels to a height considerably above that surface. This enables the lift truck operator to load the cargo by positioning the cargo support immediately below the cargo and to unload the cargo onto a storage surface within the height range.

Because lift trucks often operate on surfaces which are inclined to horizontal, the mast of lift trucks are often constructed to be pivotable about a horizontal axis extending laterally of the lift truck. A hydraulic actuator is connected between the mast and the frame of the lift truck and controlled by a manually actuated hydraulic system that permits the operator to tilt the mast forward and aft at an angle with respect to the lift truck that positions the cargo support in a horizontal orientation.

Generally, the operator tries to maintain the cargo support surface in a horizontal orientation so that the gravitational force on the cargo is not applied in a direction that has a component laterally of the support surface that could move the cargo in a horizontal direction possibly resulting in the cargo falling off the cargo support surface. When attempting to load a cargo while the lift truck is on a surface which is inclined to the bottom of the cargo, the operator can adjust the tilt angle to position the cargo support in alignment with the bottom of the cargo. The operator can also adjust the mast tilt angle when the lift truck is traveling up or down a ramp or other inclined surface in order to maintain the cargo support surface in a horizontal orientation so that the cargo will not slide horizontally on the cargo support surface.

Although the manual mast tilt system has been advantageous, it is difficult to operate accurately. The manual system relies upon the operator's vision and judgment and therefore is subject to inaccuracies resulting from optical illusions and from the vision of the operator being obscured by the cargo. When the lift truck is on a horizontal surface, it is practical to adjust the tilt angle to bring the support surface into alignment with that horizontal surface. However, if the lift truck is on an inclined surface, or traveling over a changing terrain, it is difficult for a human operator to sense the angle that provides horizontal orientation because of the absence of a horizontal reference. Additionally, if the cargo support surface is raised well above the operator's eyes, the operator's viewpoint makes it very difficult to judge horizontal and to judge alignment. The operator's vision may also be obstructed by the cargo and the lift truck's safety cage.

One approach to the reduction of this problem has been to provide a lift truck with a system that senses the angle of the mast with respect to the lift truck body or chassis. Such a system can automatically adjust the mast tilt to bring the support surface into alignment with the surface upon which the lift truck is operating and can also detect whether the operator has tilted the mast too far and created a risk of tipping the lift truck forward or of the load falling off backwards. Other prior art systems automatically move the mast to a predetermined tilt angle upon actuation by the operator.

The invention of U.S. Pat. No. 6,073,069 tries to solve these problems through a control system which compensates for mast tilt by selectively switching on solenoid valves to allow hydraulic fluid to flow from one side of the tilt cylinders to the other when a certain permissible tilt allowance has been exceeded. This system effectively keeps the cargo support surfaces of the fork parallel to the ground within a certain tolerance. However this control system does not take into account the force on the load due to acceleration arising from travel motion. Therefore an inexperienced driver can still drop the load during sudden stops or the load can shift during excessive acceleration.

Although these various mast tilt and leveling systems have improved cargo stability, they become inaccurate when the lift truck is not on a horizontal surface. More importantly, they do not take into account load instability which results from the acceleration or deceleration of the lift truck as it travels along a surface at a changing velocity.

It is therefore and object and feature of the invention to provide an automatic mast tilt angle control system which is responsive to both the direction of gravity and also the direction of the force applied to the cargo by the acceleration or deceleration of the cargo when the vehicle speed changes.

Another object and feature of the invention is to provide an automatic mast tilt system which additionally positions the mast at any tilt angle within a smoothly continuous tilt angle range instead of being confined to tilt angles only at discrete steps or increments.

### (f) BRIEF SUMMARY OF THE INVENTION

The tilt angle of the load supporting surface of a lift truck is automatically adjusted during lift truck operation to maintain the load supporting surface substantially perpendicular to the angular direction of the resultant of the forces of gravitational and travel acceleration.

To accomplish this, an acceleration sensor, also called an accelerometer, is mounted to the lift truck for sensing the angular direction of a resultant force vector which is the resultant of the gravitational acceleration force vector and the vehicle travel acceleration force vector. The acceleration sensor is connected as the feedback element of a negative feedback control system. The control system stores a reference input comprising a stored value of angular direction representing the angular direction of the resultant acceleration vector when the lift truck is at rest and the cargo support fork is horizontal. The deviation or error of the control system is the difference between the stored vector direction and the sensed direction of the resultant of the two accelerations. The controlled element of the feedback control system, to which the control system output is applied, is the mast tilt actuator of the lift truck. Therefore, the control system controllably varies the mast tilt angle to bring the currently sensed resultant angular direction into alignment with the stored reference angular direction.

### (g) BRIEF DESCRIPTION OF THE SEVERAL VIEWS OF THE DRAWINGS

FIG. 1 is a view in side elevation of a lift truck embodying the invention.

FIG. 2 is a view in side elevation of the lift truck of FIG. 1 with the lift mast tilted backward.

FIG. 3 is a view in side elevation of the lift truck of FIG. 1 with the lift mast tilted forward.

FIG. 4 is a block diagram illustrating the mast tilt hydraulic system and the negative feedback control system of the preferred embodiment of the invention.

FIG. 5 is a block diagram of an electronic controller for use as the controller of the embodiment of FIG. 4.

FIG. 6 is a diagram illustrating a PID control algorithm for the central processing unit of FIG. 5.

FIG. 7 is a diagram illustrating a standard feedback control algorithm for alternative use for the central processing unit of FIG. 5.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other circuit elements where such connection is recognized as being equivalent by those skilled in the art. In addition, many circuits are illustrated which are of a type which perform well known operations on electronic signals. Those skilled in the art will recognize that there are many, and in the future may be additional, alternative circuits which are recognized as equivalent because they provide the same operations on the signals.

### (h) DETAILED DESCRIPTION OF THE INVENTION

FIG. 1 illustrates a lift truck 10 having a lift mast 12 to which a cargo support platform, in the form of a conventional fork 14, is mounted. The lift truck 10 is provided with the conventional equipment for raising and lowering the fork 12 along the lift mast. It is also provided with a conventional hydraulic cylinder actuator 16 for tilting the mast fore and aft from its angular orientation a, in which the fork 12 is horizontal when the lift truck is on a horizontal surface, through a forward tilt angle b or a rearward tilt angle c. Preferably the actuator 16, which can be any of several prior art actuators, is connected to a control system which includes the prior art feature that it can be manually tilted by the lift truck operator when desired.

An acceleration sensor 18 is mounted to the lift truck, preferably to the lift mast 12. The purpose of the acceleration sensor 18 is to sense the direction of the resultant acceleration vector on the cargo. The sensed acceleration is the resultant of the gravitational acceleration force vector and the acceleration force vector from changes in the velocity or speed of the lift truck as it travels along a path, that is the F=ma force vector. The sensor is preferably mounted to the mast 12 so it is remote from possible damaging contact with the cargo but can sense the resultant acceleration direction on the tiltable cargo support structures. Since the angle between the mast and the support fork of most lift trucks remains constant, the sensed resultant direction of acceleration is always with reference to the cargo support. As an alternative, it is possible to mount the acceleration sensor directly on the support forks, but this increases the risk of damage to the sensor. As another alternative, it is possible to mount the acceleration sensor on the lift truck body or chassis and also sense the tilt angle between the support forks and the lift truck body. The resultant acceleration direction with respect to the support fork 14 can then be automatically be computed. However, this is not preferred because it requires needless, additional mathematical operations and opportunities for failures. In the event the lift truck were constructed to permit the angle between the support fork and the mast to be varied, this angle can also be sensed and the calculation made or the sensor can be mounted to the fork or other support surface.

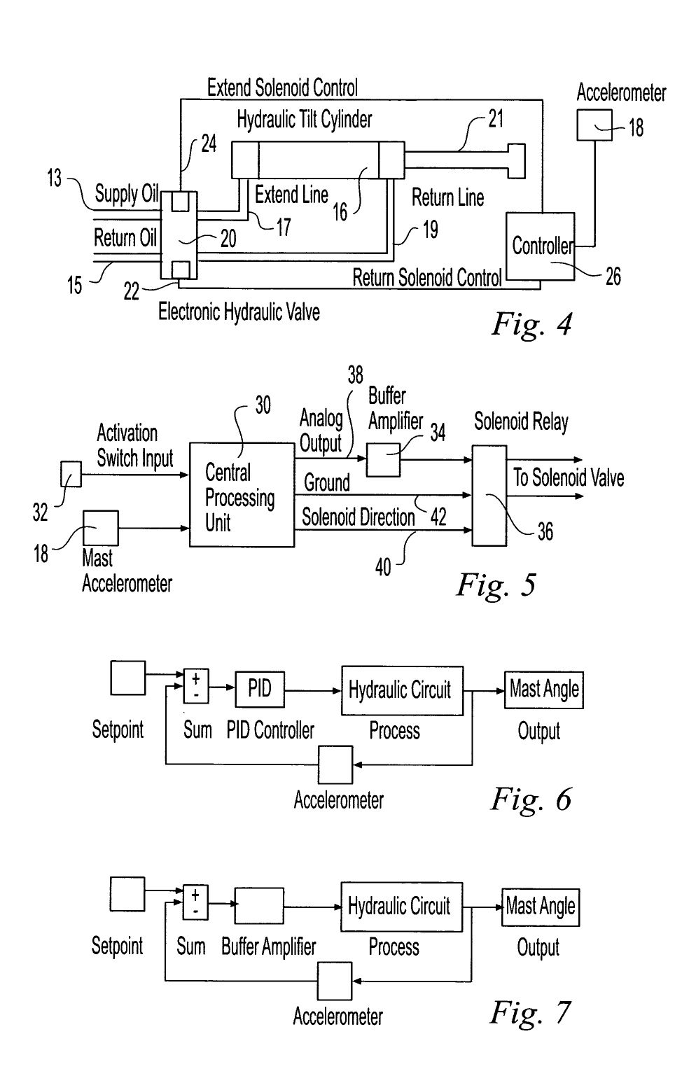

FIG. 4 illustrates the electrical control system and the mast tilt hydraulic system for the present invention. The double acting, hydraulic cylinder 16 is the tilt actuator and has its opposite ends hydraulically connected to an electronically controlled (preferably solenoid actuated), bidirectional, proportional, hydraulic valve 20 for controlling the hydraulic fluid flow to the tilt cylinder 16. Hydraulic fluid under pressure is supplied to the valve 20 through a supply line 13 and fluid is returned through a return line 15 in the conventional manner. The valve 20 is connected to the hydraulic cylinder 16 by an extend line 17 for extending the actuator arm 21 of the hydraulic cylinder 20 and a return line 19 to return or retract the actuator arm 21. The hydraulic valve 20 has its electrical control inputs 22 and 24 connected to the output of the negative feedback control system and more specifically to the controller 26 for controlling the hydraulic cylinder 16 to tilt the mast to a tilt angle within a smoothly continuous tilt angle range. The accelerometer 18 is connected to an input of the controller and is the feedback element of the control system.

FIG. 5 illustrates the controller 26 of FIG. 4. It has a central processing unit 30 which preferably consists of a Microchip PIC18F452 microcontroller with a Texas Instruments OPA547 for the buffer amplifier 34. It has the accelerometer 18 applied at one input and a momentary, single pole, single throw activation switch 32 as a second input. Active load stabilizing control of the mast is achieved by holding down the momentary SPST activation switch 32. If for any reason the switch is released, control of the mast will revert back to the operator. The preferred embodiment utilizes an Analog Devices ADXL202 accelerometer to sense the direction of the resultant force resulting from gravity and any travel acceleration. Other accelerometers can be utilized whether analog, digital, mechanical or electrical.

Three outputs from the CPU 30 are connected to a solenoid relay 36, the two outputs of which are connected to the control inputs 22 and 24 of the electrically controlled valve 20. These three outputs are an analog output 38 having a magnitude representing the magnitude of the angle of tilt through which the mast is to be moved, a direction output 40, representing the direction of tilt angle movement and a ground or common 42. These components illustrated in FIG. 5 are commonly available components and therefore their component parts and operation are not described in more detail.

FIGS. 6 and 7 represent negative feedback control algorithms for the operation of the CPU 30 of FIG. 5. Because feedback control systems and their principles of operation are well known to those skilled in the art, they are not described in detail. The use of a PID controller, as illustrated in FIG. 6 is preferred. A PID controller is a well known type of controller for negative feedback control systems. The letters of this acronym represent the first letters of the words “proportional integral derivative” and such controllers are also known as proportional+reset+derivative controllers.

The above system preferably will also incorporate safety features to make sure that the fork is at a sufficient height so that it doesn't strike the ground when the mast is tilted and the fork is operating within its normal range. The Central Processing Unit (CPU) accepts inputs from the activation switch and from the mast accelerometer. It then decides the magnitude and direction of the hydraulic solenoid through the control algorithm such as those illustrated in FIGS. 6 and 7. The CPU then outputs the correct analog output and direction. The buffer amplifier 34 provides the power for the solenoid to operate. The relay 36 provides the correct electrical connections for the direction.

If the lift truck is being retrofitted and already has a bi-directional electric proportional hydraulic valve installed, or if it is being manufactured with such a valve as original equipment, the hydraulic parts of the lift truck will remain the same. If the lift truck is being retrofitted and already has a manual hydraulic valve, a bi-directional electric proportional hydraulic valve of the type described above will be inserted in parallel with the manual hydraulic valve.

In the operation of a lift truck embodying the invention, the control system must first be initialized or calibrated. This is most easily accomplished by placing a level gauge, such as a carpenter's level, on the fork of the lift truck while the lift truck is stationary and manually tilting the mast until the fork is level. The output of the accelerometer is then stored in the storage of the microcontroller. That stored value is used as the set point for the feedback control system. The stored value represents the orientation of the plane of the support surface perpendicular to the resultant force. Of course there are other ways of inputting and storing this initial value. For example, it can be determined experimentally from one of a series of identical lift trucks and communicated to the controller by keyboard input or other data communication. The lift truck can be designed to have a selected initial value which can be stored in read only memory.

After initialization and during operation, the accelerometer senses the resultant angular direction of the component forces of gravitational and travel acceleration on the lift truck. Preferably, the instantaneous sensed values of resultant direction are averaged over a time interval to avoid unstable, transient operation and this average is compared at the summing junction of FIG. 6 or 7 to the stored initial value. The difference represents the feedback control system error. The control system then continuously tilts the mast to tilt the load supporting surface through the angular error to drive the load supporting surface substantially perpendicular to the resultant angular direction and bring the error to substantially zero, in the usual manner of a feedback control system.

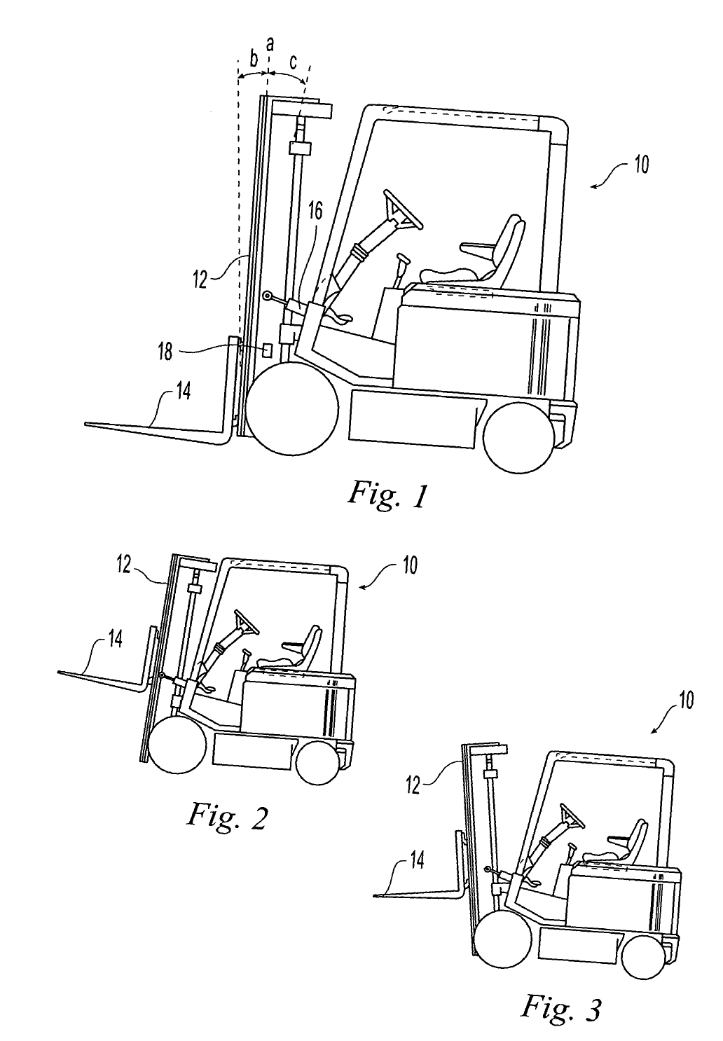

When signaled or actuated by the operator by depression of the activation switch 32, the controller of the invention takes control of the mast tilt controls. The controller monitors the influence of gravity on the mast and the influence of travel acceleration and deceleration as the vehicle transit speed changes through inputs from the acceleration sensor. The control system operates the electrically controlled valves to cause hydraulic fluid to flow to one side of the cylinder or the other to cause the cylinders to extend or retract to change the tilt angle of the mast. When the lift truck is not traveling and when the lift truck is traveling at a constant speed, the controller automatically levels the load, that is moves the support surface perpendicular to the force of gravity. When the lift truck is in transit and is accelerating or decelerating, the controller will also stabilize the load. When the lift truck accelerates, the mast will tip forward through an arc to the correct tilt angle, as illustrated in FIG. 3, to ensure that the resultant force exerted on the load is perpendicular to the fork 14 of the mast 12 so that the load doesn't move with respect to the fork. When the forklift decelerates, the mast will tip backwards slightly through an arc to the correct tilt angle, as illustrated in FIG. 2, to ensure that the resultant force exerted on the load is perpendicular to the fork 14 of the mast 12 so that the load doesn't move with respect to, or slide off the front end of, the fork 14. Consequently, an embodiment of the invention not only relieves the operator from the task of leveling the load when the lift truck is at a constant velocity, it can level the load more accurately and additionally tilts the load to stabilize it by compensating for acceleration or deceleration of the lift truck. This is particularly helpful to inexperienced drivers who might otherwise stop too rapidly and cause the load to slide off the front end of the fork.

If for any reason the controls are bumped during automatic operation, control of the mast tilt feature will revert back to the operator. (manual override). The system desirably also incorporates safety features to make sure that the forks are at a sufficient height so that they don't strike the ground when operating within their normal range.

While certain preferred embodiments of the present invention have been disclosed in detail, it is to be understood that various modifications may be adopted without departing from the spirit of the invention or scope of the following claims.

1. A lift truck, load stabilization system for controlling the tilt angle of a lifting mast having a cargo support mounted to the mast and a tilt actuator for adjusting the mast tilt angle relative to the lift truck frame, the system comprising:
a. an acceleration sensor mounted to the lift truck for sensing the angular direction of a resultant of the forces of gravitational acceleration and vehicle travel acceleration; and
b. a negative feedback control system having
i. a feedback element input connected to the acceleration sensor for feedback of said resultant angular direction,
ii. a reference input storage for storing a value of angular direction representing the resultant angular direction of acceleration when the lift truck is at rest and the cargo support is horizontal; and
iii. an output connected to control said actuator for controllably varying the mast tilt angle and bringing the resultant angular direction into alignment with the stored reference angular direction.

2. A lift truck system in accordance with claim 1 wherein the tilt actuator includes at least one double acting hydraulic cylinder actuator hydraulically connected to a bidirectional, proportional, hydraulic valve for controlling the hydraulic fluid flow to the tilt actuator, the hydraulic valve having a control input linked to the output of the negative feedback control system for controlling the actuator to tilt the mast to a tilt angle within a smoothly continuous tilt angle range.

3. A lift truck system in accordance with claim 2 wherein the control system comprises an analog proportional controller.

4. A lift truck system in accordance with claim 2 wherein the control system comprises is a PID controller.

5. A lift truck system in accordance with claim 2 wherein the hydraulic valve is electrically actuated.

6. A method for adjusting the tilt angle of the load supporting surface of a lift truck, the method comprising: adjusting the tilt angle of the load supporting surface during lift truck operation to maintain the load supporting surface substantially perpendicular to the angular direction of the resultant of gravitational and travel acceleration.

7. A method for adjusting the tilt angle of the load supporting surface of a lift truck, the method comprising:
a. storing the angular direction of gravitational acceleration upon the load supporting surface when the lift truck is at rest and the load supporting surface is substantially horizontal;
b. sensing the resultant angular direction of gravitational and travel acceleration during lift truck operation; and
c. tilting the load supporting surface through the angular difference of said angular directions to align the load supporting surface substantially perpendicular to the resultant angular direction.

8. A method in accordance with claim 7 wherein the storing step is performed by positioning the lift truck at rest with the load supporting surface substantially horizontal and storing a sensed angular direction of gravitational force.
